(19) United States
(12) Patent Application Publication
(10) Pub. No.: US 2014/0019179 A1
(43) Pub. Date: Jan. 16, 2014

(54) Forestry and Urban Forestry Project Tracking

(71) Applicant: Trimble Navigation Limited, Sunnyvale, CA (US)

(72) Inventors: Jorge Rick Gosalvez, Santa Clara, CA (US); Patrick Denis Lefebvre, Vancouver (CA)

(21) Appl. No.: 13/939,170

(22) Filed: Jul. 10, 2013

Related U.S. Application Data
(60) Provisional application No. 61/671,205, filed on Jul. 13, 2012.

(51) Int. Cl. G06Q 10/06

(52) U.S. Cl. CPC G06Q 10/063
USPC 705/7.11

(57) ABSTRACT

Novel tools and techniques for management of urban forestry projects. Some tools feature the integration of forestry tools and business intelligence techniques to provide enhanced insight into urban forestry projects and/or can incorporate data from a wide variety of data sources without the need for complex data transformation processes. In an aspect, some tools to enable urban forest project owners to capitalize on project offset credits as a revenue source. In another aspect, such tools can provide a variety of different analyses, from canopy analyses to tree health analysis, to work order generation, to carbon offset calculations, including the calculation of carbon offsets using accepted standards, to allow a project owner to quickly and easily establish the amount of offsets to which the project is entitled.

### CROSS-REFERENCES TO RELATED APPLICATIONS

This application claims the benefit, under 35 U.S.C. §119(e), from co-pending provisional U.S. Patent Application No. 61/671,205 filed Jul. 13, 2012, by Jorge Rick Gosalvez and titled “Urban Forestry and Carbon Credits” which is hereby incorporated by reference, as if set forth in full in this document, for all purposes.

This application may also be related to the following applications:

U.S. patent application Ser. No. 13/014,074, filed Jan. 26, 2011, by Richard W. Rudow et al. and titled “Tracking Carbon Footprints” (attorney docket no. 0420.04), which is hereby incorporated by reference, as if set forth in full in this document, for all purposes.

U.S. patent application Ser. No. 12/902,013, filed Oct. 11, 2010 by Jeffrey Allen Hamilton et al. and titled, “Tracking Carbon Output in Agricultural Applications” (attorney docket no. 0420.06), which is hereby incorporated by reference, as if set forth in full in this document, for all purposes.

The respective disclosures of these applications/patents are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to green infrastructure and urban forestry and more particularly, to integrated systems for tracking forestry and urban forestry projects.

### BACKGROUND

Urban forestry is an important part of the quality of life in any urban environment. Urban vegetation is important not only for aesthetic reasons, but also to enhance oxygenation of the local environment. Further, such vegetation can be an important source of carbon sequestration, and the tracking of such vegetation can provide financial benefits for municipalities. For example, local governments continually seek new funding and revenue sources. Carbon offsets have been identified as a strategic and future source of available reoccurring revenues for local governments that provide capital and contribute to addressing community initiatives.

To date, however, no comprehensive solution exists to help local governments manage urban forestry projects. Similarly, there is no comprehensive solution for carbon offset credit data collection, monitoring, management, and reporting exists. Instead, current monitoring, measuring, management, and reporting systems are siloed and manually intensive in nature. As a result, there is little integration between canopy measurement techniques, georeferenced analysis, and offset calculation, creating incomplete (and/or incompatible) data and preventing the efficient implementation and tracking of urban forestry projects. This shortcoming creates a gap between programs and regulations and the actual implementation of any projects that might take advantage of such programs or comply with such regulations.

Hence, there is a need for more robust solutions for tracking urban forestry projects.

### BRIEF SUMMARY

One set of embodiments provides tools and techniques that can provide comprehensive management of urban forestry projects. Some embodiments provide for the integration of forestry tools and business intelligence techniques to provide enhanced insight into urban forestry projects. Other embodiments can incorporate data from a wide variety of data sources without the need for complex data transformation processes. In an aspect, some such embodiments provide tools to enable urban forest project owners to capitalize on project offset credits as a revenue source. In another aspect, such tools can provide a variety of different analyses, from canopy analyses to tree health analysis, to work order generation, to carbon offset calculations. Particular embodiments can calculate carbon offsets using accepted standards, to allow a project owner to quickly and easily establish the amount of offsets to which the project is entitled.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

Merely by way of example, a method in accordance with one set of embodiments might comprise receiving (e.g., at a forestry application on a computer system comprising one or more processors) field data. Such field data can include, without limitation, data about a plurality of individual trees, data about other urban vegetation, fleet data about vehicles in a fleet operated by a project owner, and other relevant data. A number of different data sources can provide such data, such as an aircraft and/or unmanned aerial system (“UAS”), a mobile device and/or handheld optical scanner, a vehicular imaging device, a fleet management system, and/or a variety of third party data sources, to name a few examples.

In some embodiments, the method can further comprise analyzing the field data to generate georeferenced tree data. In a particular aspect of some embodiments, a business intelligence application can be used to perform the analysis. In some cases, this analysis can include analyzing different sets of field data over time, to identify changes in trees and/or other vegetation. Such changes can include, without limitation, changes in the condition of trees, changes in canopy coverage provided by trees, changes in carbon accumulation (sequestration) of one or more trees, etc. In other cases, analysis of the field data can include analyzing the field data against one or more business rules.

The method can further include adding the georeferenced tree data to a map. In some cases, the map might be developed by geospatial software and/or might be generated based on field observations from a surveying crew. In an aspect, the georeferenced tree data can be added to the map as a particular layer on the map. The method might include receiving, at the computer system, a selection of an area of the map, and/or calculating, with the computer system, an amount of carbon offsets attributable to a portion of the georeferenced tree data corresponding to the selected area of the map. In one aspect of certain embodiments, this calculation can be performed in accordance with an accepted standard for carbon offsets. In another aspect, the calculation can employ published data (e.g., data about carbon offset classifications for particular tree species, etc.), and the method can include accessing such data.

In accordance with particular embodiments, the method can include generating a report indicating the calculated amount of carbon offsets. This report might be formatted as required by a regulatory body or exchange. In some cases, the method might comprise providing a web portal, and the report can be provided via the web portal, such as, merely by way of example, displaying the report on a dashboard on the web portal.

Another set of embodiments provides apparatus. An exemplary apparatus might comprise a non-transitory computer readable medium having encoded thereon a set of instructions executable by one or more computers to perform one or more operations, including without limitation operations in accordance with methods provided by other embodiments. Merely by way of example, the set of instructions might comprise instructions for receiving, at a forestry application, field data about a plurality of individual trees; instructions for analyzing the field data, with a business intelligence application, to generate georeferenced tree data; and/or instructions for adding the georeferenced tree data to a map. The set of instructions might further include instructions for receiving a selection of an area of the map; instructions for calculating an amount of carbon offsets attributable to a portion of the georeferenced tree data corresponding to the selected area of the map, and/or instructions for generating a report indicating the calculated amount of carbon offsets.

A further set of embodiments provides systems, including without limitation computer systems. An exemplary system might comprise one or more processors and/or a non-transitory computer readable medium in communication with the one or more processors. In an aspect, the computer readable medium can have encoded thereon a set of instructions executable by the computer to perform one or more operations, including without limitation operations in accordance with methods provided by other embodiments. Merely by way of example, the set of instructions might comprise instructions for receiving, at a forestry application, field data about a plurality of individual trees; instructions for analyzing the field data, with a business intelligence application, to generate georeferenced tree data; and/or instructions for adding the georeferenced tree data to a map. The set of instructions might further include instructions for receiving a selection of an area of the map; instructions for calculating an amount of carbon offsets attributable to a portion of the georeferenced tree data corresponding to the selected area of the map, and/or instructions for generating a report indicating the calculated amount of carbon offsets.

In some cases, the system might further comprise an application on a mobile device configured to collect, extract, and/or assess at least a portion of the field data; in an aspect, the application can be configured to receive normalized difference vegetative index (“NVDI”) data from a handheld optical sensor. Alternatively and/or additionally, the system might comprise a UAS configured to collect at least a portion of the field data, and/or a vehicular imaging device, which can collect, extract, and/or assess geographical feature data, tree data, etc. In another aspect, the system might comprise a fleet management system configured to provide fleet data to other system components (such as a business intelligence application, to name one example).

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for tracking urban forestry projects, in accordance with various embodiments.

FIG. 2 is a functional diagram illustrating software components of a computer system for tracking urban forestry projects, in accordance with various embodiments.

FIG. 3 is a process flow diagram illustrating a method of tracking urban forestry projects in accordance with various embodiments.

FIG. 4 is a generalized schematic diagram illustrating a computer system, in accordance with various embodiments.

FIG. 5 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

One set of embodiments provides tools and techniques that can provide comprehensive management of urban forestry projects. In one aspect, such tools can provide a system workflow that complies with approved regulation and protocol requirements to allow users to connect, collect, extract, assess, model, plan, manage, and/or report urban forestry projects as a complete end-to-end solution. As such, some embodiments provide for the integration of forestry tools and business intelligence techniques to provide enhanced insight into urban forestry projects.

Certain embodiments can incorporate data from a wide variety of data sources without the need for complex data transformation processes and can seamlessly integrate disparate tools, such as forestry tools, geospatial tools, agronomy tools, and/or business intelligence tools. Merely by way of example, some embodiments can employ business intelligence-based tree and canopy extraction analysis and handheld sensor-based tree identification and condition assessments technologies to provide multi-source data on urban trees and vegetation. Further, various combinations of aerial surveying, terrestrial mapping and surveying, mobile software, plant recognition and condition assessment technologies, and vegetation/weed control solutions can be integrated by different embodiments to provide a provide a comprehensive data set for analysis of urban forestry conditions.

The system integration and workflow thus can provide a complete urban forestry management solution. Furthermore, by integrating such tools and data sources, some embodiments will enable approved project owners to interface with appropriate authorities and stakeholders, internal and external, to manage urban forestry projects and report appropriate data to registries, verifiers, exchanges, and/or government agencies for offset credit issuance. Hence, some such embodiments provide tools to enable urban forest project owners to capitalize on project offset credits as a revenue source. In another aspect, such tools can provide a variety of different analyses, from canopy analyses to tree health analysis; to mapping, modeling, scheduling, budgeting, and/or generating work orders; to carbon offset calculations. Particular embodiments can calculate carbon offsets using accepted standards, to allow a project owner to quickly and easily establish the amount of offsets to which the project is entitled.

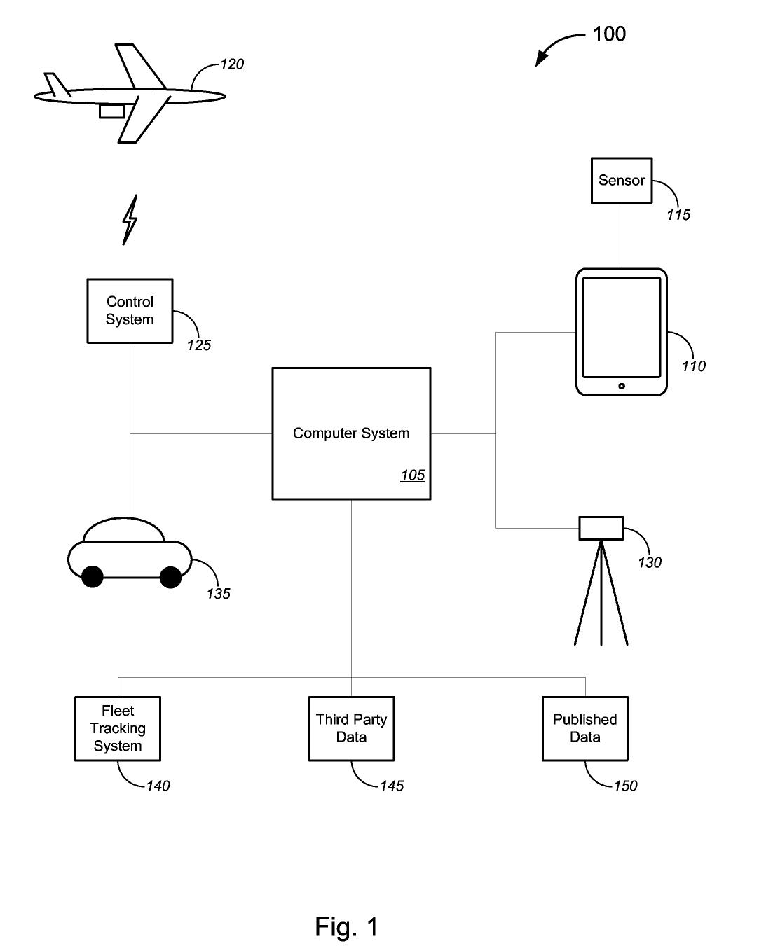

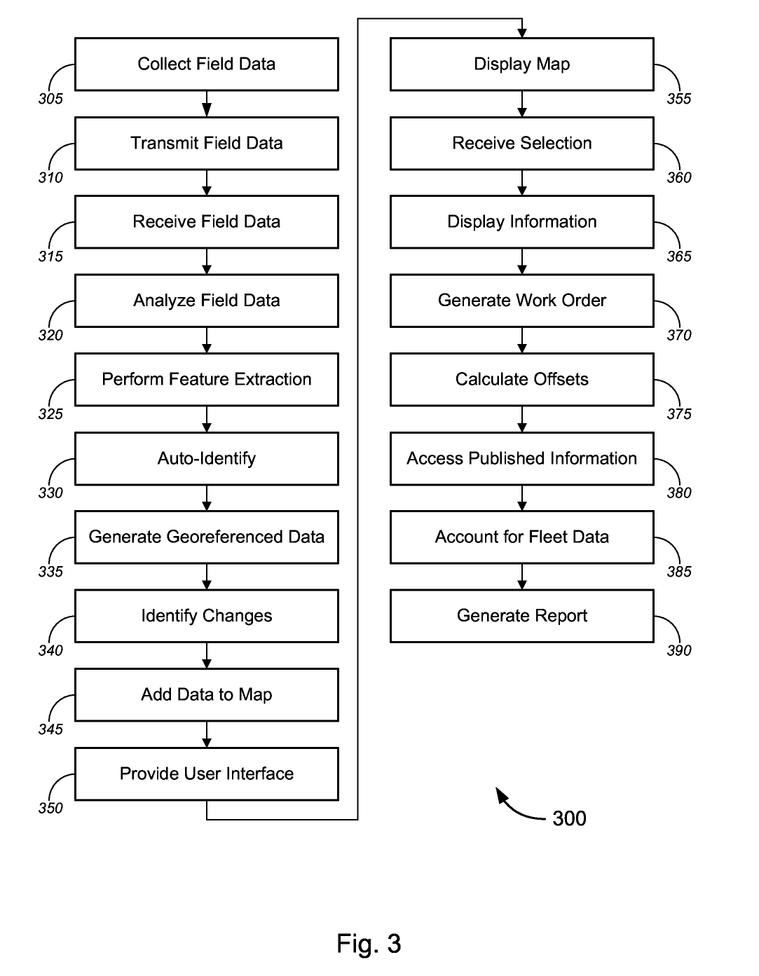

FIG. 1 illustrates an exemplary system 100 for tracking urban forestry projects. The system 100 comprises a computer system 105, which can also be referred to as an “office system,” a “server computer,” and the like. In some instances, the computer system 105 might be implemented in a hosted (e.g., software as a service) and/or cloud computing environment. The computer system 105 can be programmed to perform some or all of the operations and/or functions described herein, including but not limited to, the operations described below with regard to FIG. 3. In a general sense, however, the computer system 105 is programmed to receive field data from a variety of data sources and provide urban forestry management services and/or carbon offset calculation services. The computer system 105 can comprise a single computer or processor, a plurality of computers with various functions divided between them, the plurality of computers or processors arranged in a shared processing environment (e.g., a cloud computing environment, a grid computing environment, a computing cluster, and/or the like). Hence, when various functions are ascribed herein to the computer system 105, the reader should appreciate that such functionality can be aggregated and/or divided among one or more individual computers, and that the arrangement of such functionality among different computers or processors is discretionary.

The computer system 105 may be in communication with a plurality of data sources. In some embodiments, these data sources can be considered part of the system 100, while in other embodiments, the system might comprise the computer system 105 alone. Some examples of such data sources 120-145 are illustrated on FIG. 1, but different embodiments can use a variety of data sources and should not be considered to be limited to those illustrated on FIG. 1.

The computer system 105 can communicate with data sources using a wide variety of techniques. For example, in some cases, a data source might include media, such as a flash drive, which can be removed from the data source and inserted into the computer system 105 upload data. In other cases, the computer system 105 might communicate with a data source over network (including but not limited to the networks described in further detail below), which might be a wired network, wireless network, private network, public network, virtual private network, and/or the like, depending on the capabilities of the data source and implementation-specific considerations. In a general sense, the computer system 105 can use any appropriate mode of communication to exchange data with various data sources.

Some of the data sources might be functional to collect field data in the first instance. Merely by way of example, in some embodiments, a handheld computer 110 (e.g., a wireless phone, personal digital assistant, tablet computer, etc.) or laptop computer, etc. can serve as a field data collector and/or a data source. Merely by way of example, the handheld computer 110 can collect field data through user input (e.g. input indicating a number and/or type of trees at a particular location); photographic input (using either a camera built into the handheld computer 110 or an auxiliary camera), such as photographs of trees or other vegetation; input from sensors built into the handheld computer 110, such as a GPS receiver or other positioning sensor; and/or input from external sensors 115. For instance, in one embodiment, the handheld computer 110 might be in communication with a hand-held optical sensor, such as the Greenseeker™ sensor available from Trimble Navigation. Such sensors 115 can provide different types of data; for instance, in a particular embodiment, the sensor might collect normalized difference vegetation Index (“NVDI”) data, which can then be communicated to the handheld computer 110.

In some embodiments, the handheld computer 110 executes an application (also known as an “app”) that is configured to provide an interface for software on the computer system 105. This application can receive field data collected by the computer 110 (and/or any attached sensors 115) and/or can provide a user interface for the user to input field data. The application can collect a number of different types of field data, such as dates/times of data collection, photos, scans, auto assessment data (as described in detail below), work order actions, laser offset data, identification data (e.g., species, types, measurements, counts and/or descriptions) of individual trees (or other vegetation), data on tree health (e.g., NVDI data, data on infections, pests, etc.), location data (which can be correlated with tree identification data, other geographic feature data, and/or the like.

In some aspects, the application is configured to communicate directly with the computer system 105 (e.g. over a network, through a wireless connection, etc.) while the handheld computer 110 is still in the field. In other aspects, the handheld computer 110 might not have independent communication capabilities, and/or it might store field data locally and/or on a removable medium until the field data can be uploaded manually to the computer system 105.

Another example of a data source that can be employed by some embodiments is a UAS 120. (While FIG. 1 illustrates a UAS, it should be appreciated that other aerial platforms, both manned and unmanned, can be used for data collection in different embodiments.) In some cases, the UAS 120 is controlled by a control system 125, which can serve to communicate data between the UAS 120 and the computer system 105 (with which the control system 125 might be in contact). In other cases, the UAS 120 might communicate directly with the computer system 105 and/or might store field data on removable media for later upload to the computer system 105. In yet other aspects, an application on a handheld computer 110 can serve as a control system for a UAS.

A number of different types of UAS 120 can be used in accordance with various embodiments. Examples include the X100™, commercially available from Gatewing Nev., as well as the UAS described in International Publication No. WO 2011/131382, filed by Gatewing Nev. and published Oct. 27, 2001, and U.S. patent application Ser. No. 13/685,375, filed Nov. 26, 2012 by Joyce et al., both of which are incorporated herein by reference for all purposes. In particular, the Joyce application describes a system for performing aerial photogrammetric surveys, and such surveys can be used to collect field data.

Hence, in one aspect, a UAS 120 can be used to collect photographic field data (which can include data about trees and/or other geographical features), which can be analyzed photogrammetrically as needed to identify various dimensional and/or positional data about the trees/features. In some aspects, for example, the photographs taken by a UAS 120 can be analyzed to perform automatic aerial triangulation and/or bundle block adjustment (as known in the art) to georeference the photographs and/or orient a mosaic of photographs relative to each other. These operations can also produce point clouds in some cases. The UAS 120 can capture raw images, near infrared (NIR) and color infrared (CIR) images of the same area, which can be analyzed to produce orthophotographs, to determine vegetation reflectance (from which NVDI can be calculated), to auto assess captured images for individual tree/vegetation identification and counts (as described in further detail below), and/or to perform feature extraction. Such photographs can be also be analyzed with a feature extraction tool to identify geographic features (e.g., stop signs, roads, intersections, buildings, etc., as well as other features that can be used to orient the photograph) and/or trees or other vegetation.

Additionally and/or alternatively, however, a UAS 120 can carry additional sensor packages that can collect field data other than photographic data. Merely by way of example, a UAS 120 might have a light detection and ranging (“LIDAR”) or laser sensor, which can be used to measure canopy depth of a tree or a group of trees, perform laser offset calculations, and the like. The sensor packages can include thermal sensors as well, which can perform thermal imaging. Any of a variety of sensor types can be included to collect various geospatial and/or forestry data as needed.

In some cases, a portable scanner 130 and/or a vehicular imaging device 135 can collect field data and/or serve as a data source. A portable scanner can include any number of devices used for forestry data collection and/or geospatial data collection, including in particular a total station or a rover as described in U.S. patent application Ser. No. 13/332,648, filed Dec. 21, 2011 by Grasser et al. and titled “Enhanced Position Measurement Systems and Methods,” the entire disclosure of which is incorporated by reference herein. In another aspect, a mobile application on a handheld device 110 (or a sensor 115 in communication therewith) can perform some or all of the functions of a portable scanner 130. A vehicle can be equipped with similar hardware to provide a vehicular imaging device 135. More generally, a portable scanner 130 or a vehicular imaging device 135 can include cameras and/or the same (or similar) types of sensors described above with respect to the UAS 120 and can capture the same type of data, which can be subjected to the same type of analysis (either on the device or on the computer system 105 after upload, or both).

In addition to field data collectors, such as those described above, the system 100 can also include (or obtain data from) other data sources. Merely by way of example, a fleet management system 140 can be used as a source of data about a fleet of vehicles, which might affect any carbon offset calculations. For instance, an offset calculation might require the carbon emissions of a municipality's vehicles to be subtracted from any calculation of carbon sequestered by an urban forestry project undertaken by the municipality. A fleet management system 140 can provide data from which those emission values can be derived. Additionally and/or alternatively, data from a fleet management system 140 can be used to identify locations of various vehicles, which can then be used to populate map data, assign personnel to work orders, etc. Some exemplary fleet management systems are described in U.S. patent application Ser. No. 12/575,202, filed Oct. 7, 2009 by Joseph (published as U.S. Pre-Grant Publication No. 2010-0087984-A1); any of such systems can be employed in accordance with various embodiments.

The computer system 105 might also access third party data, which can include field data gathered by third parties, geographical feature data, map data, and/or any other type of data that can be used to support an urban forestry project. In some cases, the computer system 105 might include an interface to exchange data with third party sources (e.g., using an XML interface, an open database connection (“ODBC”) interface, etc.). In other cases, the computer system 105 can be programmed to receive data in standard and/or proprietary formats, such as shapefile, geodatabase, Keyhole Markup Language (“KML”), “0.3ds” format, Building Information Modeling (“BIM”) Collaboration Format (“BCF”), and eXtensible Markup Language (“XML”) file formats. Using such formats, data can be exchanged with a number of third party data sources 145.

In some cases, the computer system 105 might access published data 150 as well. Merely by way of example, many authorities, such as the California Air Resources Board (“CARB”) publish standards for carbon offsets and/or classification lists for various species of urban vegetation. Such published data can be accessed by the computer system 105 to provide data and/or algorithms for calculating carbon offsets or other values. Other published data can include data from various map servers, the U.S. Forest Service, National Aeronautics and Space Administration (“NASA”), the Smithsonian Institute, the Woods Hole Research Center, the California Department of Forestry and Fire Protection (“CalFire”), the American Pulpwood Association (“APA”), and/or any other public or private repository of geospatial, forestry, vegetation, and/or carbon offset data. The published data can be used for a variety of purposes, including to obtain map tiles on which tree data can be overlaid, other geospatial data, vegetation characteristics to facilitate auto assessment of photographs, carbon offset classifications and calculations, etc.

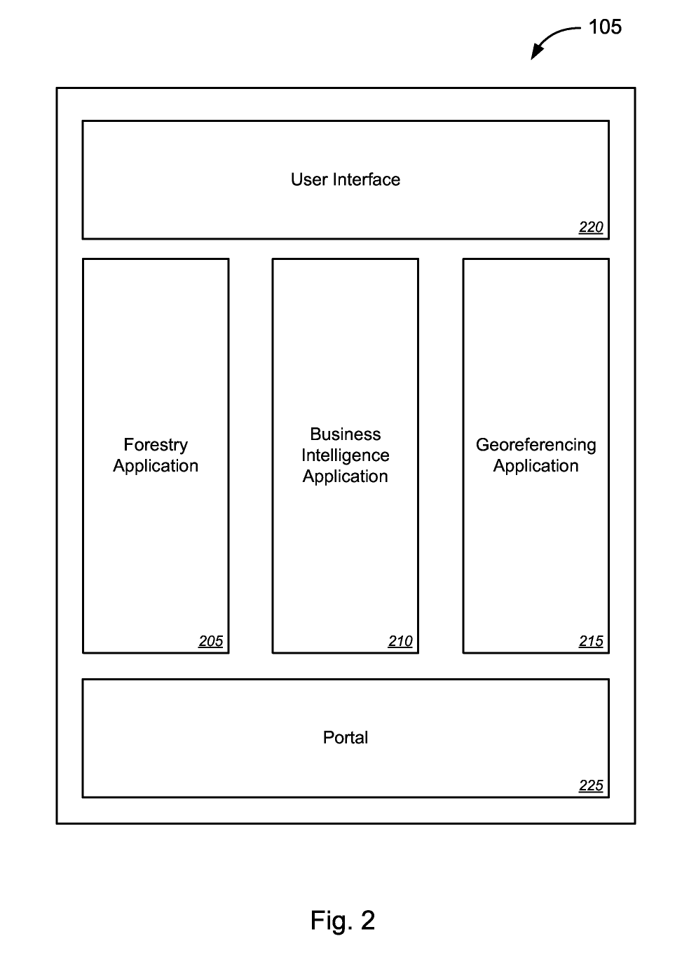

FIG. 2 illustrates a functional architecture of a computer system 105, in accordance with one set of embodiments. Although the architecture illustrated by FIG. 2 can be employed by various embodiments, the skilled reader should appreciate that other architectures can be used in accordance with other embodiments, and that the functions ascribed to different components of the architecture can be arranged in a variety of different ways.

The software architecture of computer system 105 illustrated by FIG. 2 can comprise a forestry application 205. One example of a forestry application is the Cengea™ application available from Trimble Navigation. The forestry application 205 includes functionality to receive and manage field data, especially field data relating to trees or other vegetation. As such, the forestry application 205 can serve as the interface with some of the data sources (especially the data collectors) and can providing intake and initial processing of the data from the data collectors. The forestry application 205 can apply some business intelligence rules to the field data and can perform a variety of operations, such as managing (e.g., budgeting, scheduling, planning, etc.), visualization of field data (e.g., mapping georeferenced field data, etc.), modeling of planned forestry projects, and the like.

The architecture might further comprise an additional business intelligence application 210, an example of which is the eCognition™ application available from Trimble Navigation. The data received by the forestry application 205 can comprise a very large data set, and the business intelligence application 210 can provide a tool to perform extensive analysis on large data sets. Further, the business intelligence application 210 can incorporate other types of data, including field data, such as fleet data received from a fleet management system, geographical feature data, and/or the like. The business intelligence application 210, for example, can georeference various data, apply business rules to the analysis and/or output of the data, and allow powerful searching and sorting capabilities. Further, the business intelligence application 210 can provide an analysis engine to perform carbon offset calculations described herein.

In some cases, the business intelligence application 210 and the forestry application 205 might be incorporated within the same software package or application. In other cases, the functionality of the business intelligence application 210 and the forestry application 205 might overlap in some regards; for instance, the forestry application 205 might include some business intelligence functionality (for example, to apply business rules during the intake and processing of field data), and/or the business intelligence application 210 might include modeling functionality for large data sets. In any case, the business intelligence application 210 and the forestry application 205 can work in a tightly integrated fashion, sharing data back and forth in successive operations, or even operating on the same data model simultaneously.

In some cases, the architecture can include a geospatial application 215. The geospatial application 215 can receive geographic feature data (from aerial or terrestrial surveys, for example) and georeference such data to provide point cloud data sets, map data sets, and the like. These data sets can be provided as input, for example, to the business intelligence application 210, which can correlate the georeferenced forestry data (e.g., georeferenced data about individual trees and other vegetation) with the data from the geospatial application 215 to enable, for example, the display of trees on a map, the graphical selection of groups of trees from a map, and/or the like. The geospatial application 215 can be responsible for creating map tiles from geospatial data, upon which the forestry data can be layered, etc. (In some embodiments, the forestry application 205 might perform some or all of the functions of the geospatial application 215, and/or the system might utilize map tiles provided by a map server, in which case the geospatial application 215 might not be necessary.)

In some cases, the architecture comprises a user interface 220. In certain embodiments, the forestry application 205 might provide the user interface 215, while in other embodiments, the business intelligence application 210, geospatial application 215, or another application might provide the user interface 220. In particular embodiments, a combination of applications might provide the user interface 220. In any case, the user interface 220 can allow users to interact with the computer system 105. A variety of user interfaces may be provided in accordance with various embodiments, including without limitation graphical user interfaces that display, for a user, display screens for providing information to the user and/or receiving user input from a user.

Merely by way of example, in some embodiments, the computer system 105 may be configured to communicate with a client computer via a dedicated application running on the client computer; in this situation, the user interface 220 might be displayed by the client computer, based on data and/or instructions provided by the computer system 105. In this situation, providing the user interface might comprise providing instructions and/or data to cause the client computer to display the user interface. In other embodiments, the user interface may be provided from a web site, e.g., by providing a set of one or more web pages, which might be displayed in a web browser running on the user computer and/or might be served by a web server. In various embodiments, the computer system 105 might comprise the web server and/or be in communication with the web server, such that the computer system 105 provides data to the web server to be incorporated in web pages served by the web server for reception and/or display by a browser at the user computer 105.

Merely by way of example, the architecture of the system might further comprise a web portal 225, which can be provided by the web server and/or can comprise one or more web pages, frames, and/or other components (some or all of which might be updated dynamically). In an aspect, the portal can be available to stakeholders, such as citizens, project management, business partners, project workforce, etc. Each type of stakeholder can have different levels of access (which can be configured by the project management if desired). For example, citizens might be limited to an inventory map with some statistics (number of jobs/service, number trees, community benefits, tree programs, plans, and information). Project management might have full access, but business partners might be limited to approved contracts, work schedule, plans, contacts, etc.

In a particular aspect, the portal 225 can comprise a number of dashboards, which each can provide different types of information (depending on the user's level of access). In a particular case (e.g., for project management), the portal might be configured to provide reports, including without limitation reports regarding carbon offsets, as described further below. Dashboards and reports can include, but are not limited to, information such as the following: number of projects underway or planned, number of trees in one or more projects, number of jobs provided by one or more projects, percentage of canopy coverage, total carbon sequestered, net carbon offset provided by one or more, links to local/regional “plans and approved documents,” link to “approved methods.” Dashboards and reports for work orders (which might be available to management only) can include information such as number of crew jobs, number of contracted jobs, number of citizen requests, number of hours required for a particular job, area of a job, tree damage impact assessments (in dollars or service hours), and the like. Management reports and dashboards can include information including, but not limited to, the following: percent of canopy right of way, percent of canopy private, number of trees by land use, percent of trees by land use, number of species, percent of species, percent of genus, percent of family, number of trees public, percent of trees public, number of trees private, percent of trees private, number of trees dead, percent of trees dead, number of trees need work, percent of trees need work, city goal/objective vs. actual, tree density per capita, canopy density per capita, tree density per tract, canopy density per tract, tree density per council district, canopy density per council district, number/percent of trees at X diameter at breast height (“DBH”) number/percent of trees at Y DBH, number/percent of trees at Z DBH, number of potential planting plots, etc. Further, as explained below, dashboards might also provide detailed reports on carbon offset information, including credits exercised and/or credits available, carbon dioxide measurements, etc.

In an aspect, the portal 225 (and/or user interface 220 if separate from the portal 225) can provide a map view (e.g., in one dashboard) and/or a tabular view (e.g., in another dashboard) with user interface elements to select for the display of various parameters for various areas on the map. The map can be configured to display forestry data and/or geographic feature data (such as buildings, roads, etc.), simultaneously if desired, using various layers, in two or three dimensions. For example there might be separate layers for parcels and/or land use, rights of way, building footprints, tree inventory, urban tree canopy boundaries, work orders, and the like. These layers (some of which might be available only to certain users can be activated or deactivated selectively to provide the desired information. In an aspect, the map view can be zoomed as desired, and areas on the map can be selected; in another aspect, another dashboard might display detailed information (such as the information described above) for the selected area. In some aspects, the map can be populated with icons that represent the species, health and/or size of individual trees or clusters of trees. Such functionality can be provided by the analytical tools of the business intelligence application 210.

As noted above, the architecture depicted by FIG. 2 is intended to be exemplary, rather than limiting, in nature, and the skilled reader should appreciate that various components of the architecture can be combined and/or divided in many different ways. Similarly, the functionality attributed to one component can be divided among one or more other components. Merely by way of example, in some cases, the business intelligence application 210 might include the functionality of the forestry application 205 and/or the geospatial application 215. As another example, in some cases, the portal 225 might provide the entire user interface 220, while in other cases, the portal 225 might provide limited functionality and reporting, with a different user interface (e.g., a dedicate client or server console) might provide additional functionality, such as data analysis, implementation of business rules, more robust configuration and searching, etc.

FIG. 3 illustrates an example of various methods that can be used to track urban forestry projects. It should be appreciated that the various techniques and procedures of these methods can be combined in any suitable fashion, and that, in some embodiments, the operations depicted by FIG. 3 can be considered interoperable and/or as portions of a single method; nonetheless, some methods might include only a subset of the operations depicted on FIG. 3. Similarly, while the techniques and procedures are depicted on FIG. 3 and/or described in a certain order for purposes of illustration, it should be appreciated that certain procedures may be reordered and/or omitted within the scope of various embodiments. Moreover, while the methods illustrated by FIG. 3 can be implemented by (and, in some cases, are described below with respect to) the system 100 of FIG. 1 (or components thereof, such as the computer system 105 of FIGS. 1 and 2 and/or the components thereof), these methods may also be implemented using any suitable hardware implementation. Similarly, while the system 100 of FIG. 1 (and/or components thereof) can operate according to the methods illustrated by FIG. 3 (e.g., by executing instructions embodied on a computer readable medium), the system 100 can also operate according to other modes of operation and/or perform other suitable procedures.

In some embodiments, a method 300 might comprise collecting field data (block 305) or other relevant data. As noted above, the field data can include a variety of different types of data, including in particular, data (such as photographic data, LIDAR, laser offset, or other scanner data, geographical feature data, NVDI data, and other qualitative or quantitative data about numbers, types, condition, and/or size) about individual trees, groups of trees and/or other urban vegetation, geographical feature data, and the like. Techniques used to collect field data can vary with the nature of the field data itself. Merely by way of example, as noted above, a number of field data collectors can be used to collect field data; such collectors can include, without limitation, a UAS (or other aerial platform), an application running on mobile device (such as a hand-held computer, which might or might not employ a sensor, e.g., a laser, to collect some of the data), a vehicular imaging device, terrestrial and/or aerial survey devices (such as total stations, cameras, and/or the like).

At block 310, the method 300 can comprise transmitting the collected field data. Similar to the collection of data, the transmission of field data to the computer system can use a variety of different techniques, depending on the nature of the data collector. Merely by way of example, as noted above, some devices might upload data to the computer system over a wireless or wired network, while other devices might employer a removable medium that can be inserted into the computer system (or in other computer, such as a client computer) to upload the field data. More broadly, in the appropriate technique can be used to transfer data from a data collector to the computer system. At block 315, then, the computer system can receive the field data, depending on how the data was transmitted. In some cases, the computer system might pull data from data collectors, third-party data sources, etc. In other cases, such devices and/or data sources might push data to the computer system.

The computer system might receive other data as well, such as fleet data from a fleet management system or classification data about tree species. Fleet data can include status information about individual vehicles, such as fuel consumption, emissions, movement, location, and/or the like. Fleet data can also include summary about a number of vehicles in a fleet. As described below, fleet data can be used in the correct relation of carbon offsets, for example to account for carbon emissions of vehicles in the fleet. Additionally and alternatively, the computer system might receive third-party data, such as data from a map server (which could be a public map server or a private map server), data about trees, vegetation, or geographical features compiled by a third-party, such as a service bureau, etc. Such third-party data can be combined with data collected by the data collectors to produce a comprehensive data set, as necessary.

In an aspect, the method 300 can include, at block 320, analyzing the field data. In certain embodiments, some or all of the analysis might be performed by a business intelligence application and/or a forestry application, or even, in some cases, by a mobile device or other data collector. In other cases, a portion of the analysis might be performed by other system components. Analysis of the data can take many different forms, depending on the nature of the field data and the desired output.

Merely by way of example, in one aspect, the analysis of the field data might include performing a feature extraction operation on some or all of the field data (block 325). For instance, some of the field data might include photographic data of trees, vegetation, or other geographic features. (Such data may be collected by a camera on a handheld device, by a vehicular imaging device, by a UAS, and/or the like.) In such cases, feature extraction techniques, several of which are known to those skilled in the art, can be used to identify individual trees, buildings, roads, and/or any other geographic features captured in the photographic data.

Similarly, in some embodiments, analyzing the data can include performing automatic identification of trees and vegetation based on field data (block 330). Merely by way of example, based on one or more rule sets and/or classification systems, the system can identify one or more species of tree (or other vegetation) in a photograph. For instance, the system might compare the image to several reference images or classification listings, and the tree (or other vegetation) can be identified as the closest match to the photograph. These techniques can be used on photographs of the entire tree (or other vegetation) and/or photographs of a portion of the tree or vegetation, such as a close-range photograph of a leaf.

In some embodiments, the analysis of the field data can include generating georeferenced tree data (block 335). For example, in some embodiments, the business intelligence application (or another application) can correlate field data about individual trees groups of trees with position data captured simultaneously (or at another time) about the location of those trees. Merely by way of example, field data about a particular tree might include a photograph of that tree taken by a handheld computer, along with NVDI data captured by a sensor connected to the handheld computer and positioning data collected by a laser. At the same time, the application on the handheld computer my capture position and/or orientation data about the location of the handheld computer. The separate data elements can be correlated to identify a location of the photographed tree, and the georeferenced data about the tree can be integrated into another data set comprising general feature data about the area.

In an aspect, analysis of the field data (or other data) can include analyzing the data against one or more business rules. Such business rules can be default rules provided by the business intelligence application, and/or they can include customized rules specified by the urban forestry project owner. Merely by way of example, the system can match photographs of trees to addresses/parcels of land, based on business rules that correlate GPS coordinates with street addresses or other legal descriptions of property. As another example, the precision and/or accuracy of the data might depend on the device (e.g., a photograph taken with a wireless phone and tagged with a GPS fix might not be as precise or accurate as data collected with a mobile scanner, with high resolution images and laser position readings taken from a known reference point). In such cases, the system can apply business rules to the data analysis to account for these differences in accuracy and/or precision and can consolidate data with a number of different levels of precision. From these examples, the skilled reader can understand that a number of business rules might be applied to the analysis of the data.

In some cases, the system might be configured to receive multiple sets of field data over time; from this field data, the analysis, therefore, can include identifying changes in the georeferenced tree data over time (block 340). By way of example, a set of field data collected at one point time might indicate that a tree in a particular location is a particular size, condition (e.g., relative health), canopy, carbon accumulation, and/or other parameters. A set of field data collected at a later point time might indicate that a tree in the same location has a larger size, different condition, different amount of carbon accumulation, different sized canopy, etc. By geo-referencing both sets of data, the computer system can ascertain that both of the data pertain to the same tree and can identify any changes in such parameters. Likewise, changes in the quantity of trees in a particular area can be tracked. Such changes can be stored and/or displayed, as noted below.

In some cases, the method 300 includes adding georeferenced data to a map (block 345), and/or generating a map from the georeferenced data. For instance, in some cases, a map of the general area as the field data pertains can be obtained from a third party map server (e.g., those operated by Google™, MapQuest™, Microsoft™ Esri™, Tekla™ and the like). Because the field data is georeferenced, and such maps are also georeferenced, the field data can be inserted in the map at the appropriate locations and/or overlaid with other geospatial data. Alternatively and/or additionally, if the field data includes general feature data about the area, a map can be generated from this general feature data, and field data about the trees can be inserted in this map as well.

The method 300, in the illustrated embodiment, further comprises providing a user interface to allow interaction between a user (e.g., an administrator, a stakeholder, etc.) and the computer system (block 350). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies, to name but a few examples.

In many cases, providing a user interface will comprise providing one or more display screens, e.g., portal dashboards, screens for performing administration, data analysis, etc., each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output.

Merely by way of example, in a set of embodiments, the user interface can display a map (block 355) or a portion of a map, which, as noted above, can include the georeferenced tree data (and/or other georeferenced data). In one aspect, the map can show a general area that includes the urban forestry project, and the method can show various features reflected by the elected field data (or third-party data). Such features can include cartographic displays of parcels, streets, buildings, and or the like, as well as individual trees, groups of trees, and/or other urban vegetation. Depending on the configuration of various embodiments, the map can have a variety of additional features. Merely by way of example, in some cases the analysis of the data can include extrapolating three-dimensional information from the field data, and some or all of the map can be displayed in three dimensions. In other cases, the map might feature graphical indicators of various parameters, such as icons that represent the number, size, and/or health or condition of a tree or group of trees. In an aspect of some embodiments, the map display can feature extent groupings that match the map scale. For example, at a relatively high scale, the map might display a single icon for each tree, while at a lower scale, the map might display the same icon for a group of trees. (It should be noted that the display options are not limited to map displays. Various embodiments can display data in tabular form, using graphics other than map displays, and any other appropriate visualization techniques.)

At block 360, the method 300 might comprise receiving a selection of a set of tree data. In a particular aspect, this can include the selection of an area of the map, although the tree data could be selected from a table, etc. as well. The skilled reader will appreciate that many different techniques can be used to allow a user to select an area of a map. Merely by way of example, the computer system might receive user input in the form of a mouse-drag or touch selection of a portion of the displayed map, and area within the selection can be considered the selected area. Alternatively or additionally, the map might feature navigation icons, such as arrows to scroll the map in different directions, and/or control to zoom the map to different levels of magnification. Such scrolling and zooming operations can also be used to select an area of the map. In some cases, keyboard commands can be used to select areas of the map as well, and any other suitable technique can be used to allow the user to select an area of the map.

The system can perform various operations in response to receiving a selection of a map (and/or other user input providing further direction). Merely by way of example, in some cases, the system might display various types of information, such as the information described above, e.g., in one or more dashboards (block 365) about the selected area of the map (and/or trees or vegetation located therein). In a particular aspect, the system can display, e.g., on the selected portion of the map, detailed data about trees or other vegetation, including, for example, any changes over time identified in the georeferenced data for various trees. Such changes can include, without limitation, changes in quantity, changes in size, changes in condition (e.g., health), changes in canopy coverage, changes in carbon accumulation of various trees, and/or the like. This data can be displayed in graphical and/or tabular form.

Alternatively and/or additionally, the system might display (e.g. superimpose on a portion of the map and/or in a dashboard adjacent the map) information and/or statistics about trees located within the selected area of the map. Such information/statistics can include data about individual trees, such as size condition, and/or the like and/or statistics about some or all of the trees within the selected area, such as numbers of different types of trees, average condition of trees, total canopy coverage, and/or the like.

In some cases, the method 300 can comprise generating one or more work orders (block 370), which might (or might not) be related to a selected portion of the map. In some cases, the work orders can be generated based on user input, which might result from a user's review of the selected area map, and/or from input from the field by way of an application on a mobile device. In other cases, the work orders may be generated automatically, based on the system's analysis of the trees in the selected area (perhaps based on user input). Merely by way of example, if the system detects an area of insufficient canopy coverage, the system might initiate (or prompt the user to initiate) the work order to place additional trees that could provide additional canopy coverage. Similarly, if the system identifies an area of the map in which tree health is substandard, the system may generate and/or propose a work order to send a crew to inspect and/or treat those trees. In a particular example, the system might a work order to a field crew, which would perform the work and close the work order; the system could then update the status to show the work order as complete.

At block 375, the method 300 comprises calculating an amount of carbon offsets attributable to the portion of the tree data that corresponds to the selected portion of the map. In one aspect, this calculation is performed with an accepted standard for carbon offsets. Merely by way of example, the authority that owns the urban forestry project might be subject to a particular local, state, and/or federal regulatory scheme that specifies the standard to which carbon offsets must be calculated. In other cases, a third-party authority might specify the standard, such as an exchange or market for carbon offsets. One example of such a standard is the California Environmental Protection Agency air resources Board (“CARB”) Compliance Offset Protocol for US Forest Projects. In an embodiment, the system can be programmed to ensure that all necessary factors are taken into account in performing the calculation of offsets resulting from an urban forest project and/or the portion of that project in the selected area of the map.

In some cases, the system may be programmed with formulas that can be used to calculate carbon offsets in accordance with a specified standard. In other cases, the system may be configured to rely on published data about the standard, in order to ensure that the khaki election complies with all current requirements. Hence, the method might include accessing published information (block 380) from a third party data source; such published information can include classification listings for various tree species, which can be used in automatic identification of species (as described above), carbon offset classifications (which can be used to determine how much offset can be accorded to a particular tree or other vegetation), carbon offset calculation formulas, offset credit values, etc., which can be used in performing the calculation of carbon offsets and values.

As noted above, in some cases, the system can receive and/or process fleet data from a fleet management system. Correspondingly, in a particular aspect of some embodiments, the calculation of carbon offsets can account for the fleet data (block 385). Merely by way of example, the system may calculate the amount of carbon (or other greenhouse gas) emissions that results from the project's fleet of vehicles over a certain period of time, based on measured parameters of the status of vehicles, such as emissions over the period of time, fuel consumed over that period of time, miles driven, time idling, and/or any other parameters that can be used to activate carbon emissions. If the analysis of the geo-referenced tree data produces a calculation that the urban forestry project is entitled to claim a certain amount of carbon offsets, the system might account for the fleet data by subtracting the amount of carbon emissions from the amount of offsets to its project is entitled. (It should be appreciated that this example may be simplified for ease of illustration, and that the actual calculations to account for the fleet data may be more complex.)

The method, at block 390, can further comprise generating a report indicating the calculated amount of carbon offsets and/or associated values. In a particular aspect, access to this report can be provided through the web portal (for instance, by displaying the report on a dashboard, making the report available for download from the portal or a dashboard, etc.). In other cases, the report can be provided in another suitable manner, including by email, by hard copy, and/or the like. In some cases, the report might be electronically submitted by the system to an authority or market tasked with awarding carbon offsets. Hence, in some embodiments, the report might be formatted in a format that is acceptable to the authority. The report can then be provided to the authority (e.g., an organization, verifier, registry, exchange, etc.) in compliance with the requirements of that authority.

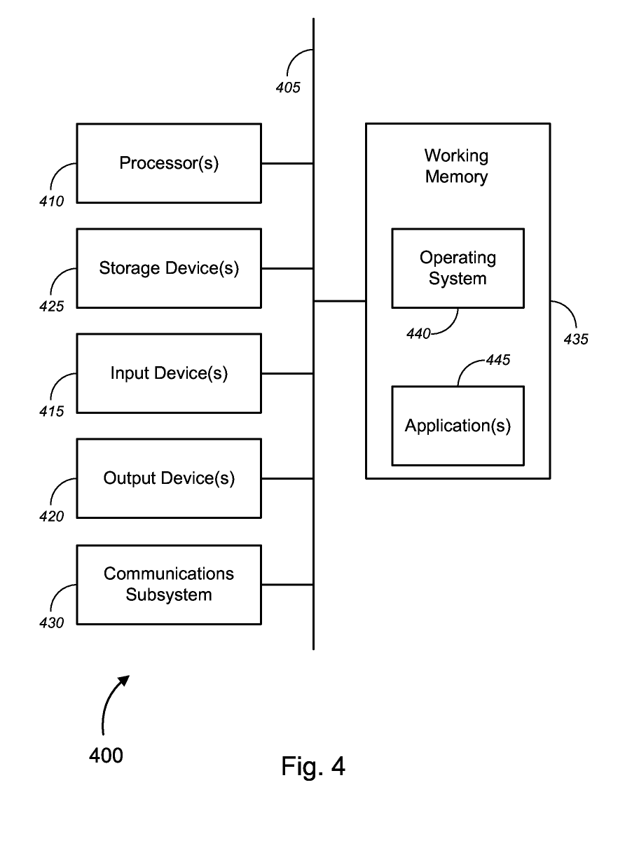

FIG. 4 provides a schematic illustration of one embodiment of a computer system 400 that can perform the methods provided by various other embodiments, as described herein, and/or can function as an office computer, computer system, fleet management system, handheld computer, UAS control system, and/or the like. It should be noted that FIG. 4 is meant only to provide a generalized illustration of various components, of which one or more (or none) of each may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, and/or the like); one or more input devices 415, which can include without limitation a mouse, a keyboard, touchpad, sensors, and/or the like; and one or more output devices 420, which can include without limitation a display device, a printer and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 430 may permit data to be exchanged with a network (such as the network described below, to name one example), with other computer systems, and/or with any other devices described herein. In many embodiments, the computer system 400 will further comprise a working memory 435, which can include a RAM or ROM device, as described above.

The computer system 400 also may comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 425. Volatile media includes, without limitation, dynamic memory, such as the working memory 435. Transmission media includes, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

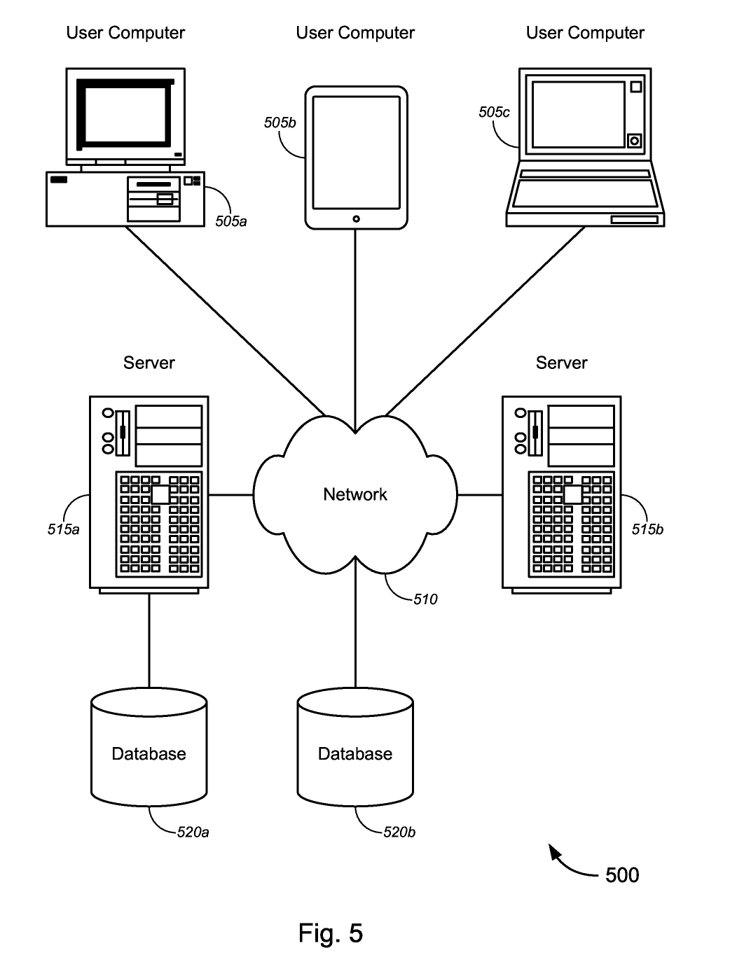

As noted above, a set of embodiments comprises systems for tracking urban forestry projects. FIG. 5 illustrates a schematic diagram of a system 500 that can be used in accordance with one set of embodiments. The system 500 can include one or more user computers 505, which can include handheld computers (such as those described above), other field data collection devices, clients used to interface with the computer system 105 described above, etc. A user computer 505 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer 505 can also have any of a variety of applications, including one or more applications configured to perform methods provided by various embodiments (as described above, for example), as well as one or more office applications, database client and/or server applications, and/or web browser applications. Alternatively, a user computer 505 can be any other electronic device, such as a thin-client computer, Internet-enabled mobile telephone, and/or personal digital assistant, capable of communicating via a network (e.g., the network 510 described below) and/or of displaying and navigating web pages or other types of electronic documents. Although the exemplary system 500 is shown with three user computers 505, any number of user computers can be supported.

Certain embodiments operate in a networked environment, which can include a network 510. The network 510 can be any type of network familiar to those skilled in the art that can support data communications using any of a variety of commercially-available (and/or free or proprietary) protocols, including without limitation TCP/IP and the like. Merely by way of example, the network 510 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515. Merely by way of example, in one embodiment, a server computer 515 can serve as the computer system 105 illustrated in FIGS. 1 and 2. Multiple server computers 515 might be configured to execute various software applications described above, or all of the applications might execute on a single server computer 515. In some cases, the functions of one or more servers 515 can be performed by a cloud environment.

As another example, one of the servers 515 may be (or comprise) a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 505 and/or another server 515. In some embodiments, an application server can create web pages dynamically for displaying the information in accordance with various embodiments, such as pages to display the portal and dashboards described above, to name one example. Data provided by an application server may be formatted as one or more web pages (comprising HTML, JavaScript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520, which can store urban forestry data, classification lists, geospatial data, etc. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle database, that is adapted to store, update, and retrieve data in response to SQL-formatted commands. In other cases, one or more databases might be geo databases and/or spatial databases. The database(s) might be controlled and/or maintained by one or more database servers, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, at a forestry application on a computer system comprising one or more processors, field data about a plurality of individual trees;
analyzing the field data, with a business intelligence application on the computer system, to generate georeferenced tree data;
adding, with the computer system, the georeferenced tree data to a map;
receiving, at the computer system, a selection of a set of the georeferenced tree data;
calculating, with the computer system, an amount of carbon offsets attributable to the set of georeferenced tree data, in accordance with an accepted standard for carbon offsets; and
generating a report indicating the calculated amount of carbon offsets.

2. The method of claim 1, wherein receiving a selection of a subset of the georeferenced tree data comprises receiving a selection of an area of the map, and wherein calculating an amount of carbon offsets comprises calculating an amount of carbon offsets attributable to a portion of the georeferenced tree data corresponding to the selected area of the map.

3. The method of claim 1, further comprising collecting the field data with an application running on a mobile device.

4. The method of claim 3, wherein collecting the field data comprises receiving, at the mobile device, normalized difference vegetative index (“NVDI”) data from a handheld optical sensor.

5. The method of claim 1, further comprising collecting the field data with a mobile platform.

6. The method of claim 5, further comprising:
transmitting the field data from the mobile platform.

7. The method of claim 5, wherein the mobile platform is an aerial platform.

8. The method of claim 5, wherein the mobile platform is a vehicular imaging device.

9. The method of claim 5, further comprising collecting additional field data with the mobile platform, the additional field data comprising geographical feature data.

10. The method of claim 1, further comprising performing automatic identification on the field data to identify individual trees.

11. The method of claim 1, further comprising assessing, with the computer system, a condition of one or more trees based on the field data.

12. The method of claim 1, wherein receiving field data comprises receiving at least a portion of the field data from a third-party data source.

13. The method of claim 1, further comprising receiving, at the computer system, fleet data from a fleet management system, the fleet data comprising status information about one or more vehicles.

14. The method of claim 13, wherein calculating an amount of carbon offsets comprises accounting for the fleet data.

15. The method of claim 1, further comprising:
receiving additional field data at a subsequent time;
analyzing the additional field data with the business intelligence application to identify changes to the georeferenced tree data; and
displaying, on at least a portion of the map, identified changes to the georeferenced tree data.

16. The method of claim 15, wherein analyzing the additional field data to identify changes to the georeferenced tree data comprises identifying a change in a condition of one or more trees, identifying a change in a canopy coverage provided by one or more trees, or a change in a carbon accumulation of one or more trees.

17. The method of claim 1, wherein analyzing the field data comprises analyzing the field data against one or more customized business rules.

18. The method of claim 1, further comprising:
providing access to the report with a web portal; and
displaying the report on one of a plurality of dashboards on the web portal.

19. The method of claim 1, further comprising:
displaying at least a portion of the map, which graphically illustrates at least a portion of the georeferenced tree data.

20. The method of claim 19, wherein the at least a portion of the map is displayed in three dimensions, and wherein the method further comprises extrapolating three dimensional information from the field data.

21. The method of claim 19, wherein the map comprises graphical indicators of the size and health of individual trees.

22. The method of claim 1, wherein the field data comprises additional field data about urban vegetation.

23. The method of claim 1, wherein calculating an amount of carbon offsets comprises accessing, with the business intelligence application, published data about carbon offset classifications.

24. The method of claim 1, further comprising:
generating one or more work orders for urban forestry work, based on the georeferenced tree data.

25. The method of claim 1, wherein the forestry application and the business intelligence application are incorporated in the same software application.

26. An apparatus, comprising:
a non-transitory computer readable medium having encoded thereon a set of instructions executable by one or more computers to perform one or more operations, the set of instructions comprising:
instructions for receiving, at a forestry application, field data about a plurality of individual trees;
instructions for analyzing the field data, with a business intelligence application, to generate georeferenced tree data;
instructions for adding the georeferenced tree data to a map;
instructions for receiving a selection of a set of the georeferenced tree data;
instructions for calculating an amount of carbon offsets attributable to the set of georeferenced tree data, in accordance with an accepted standard for carbon offsets; and
instructions for generating a report indicating the calculated amount of carbon offsets.

27. A system, comprising:
a computer comprising:
one or more processors; and
a non-transitory computer readable medium in communication with the one or more processors, the computer readable medium having encoded thereon a set of instructions executable by the computer to perform one or more operations, the set of instructions comprising:
instructions for receiving, at a forestry application, field data about a plurality of individual trees;
instructions for analyzing the field data, with a business intelligence application, to generate georeferenced tree data;
instructions for adding the georeferenced tree data to a map;
instructions for receiving a selection of a set of the georeferenced tree data;
instructions for calculating an amount of carbon offsets attributable to the set of georeferenced tree data, in accordance with an accepted standard for carbon offsets; and
instructions for generating a report indicating the calculated amount of carbon offsets.
